(19) United States
(12) Patent Application Publication
(10) Pub. No.: US 2019/0174920 A1
(43) Pub. Date: Jun. 13, 2019

(54) COOKER AND KITCHEN FURNITURE ITEM EQUIPPED WITH COOKER

(71) Applicants: Mitsubishi Electric Corporation, Tokyo (JP); Mitsubishi Electric Home Appliance Co., Ltd., Fukaya-shi, Saitama (JP)

(72) Inventors: Akihiko KOBAYASHI, Tokyo (JP); Hayato YOSHINO, Tokyo (JP)

(21) Appl. No.: 16/099,370

(22) PCT Filed: Nov. 17, 2016
(86) PCT No.: PCT/JP2016/084030

§ 371 Date: Nov. 6, 2018

(30) Foreign Application Priority Data
Jul. 29, 2016 (JP) 2016-149832

(51) Int. Cl. A47B 88/463; A47B 77/08; A47B 88/437; H05B 6/12; A47B 88/41

(52) U.S. Cl. CPC A47B 88/463; A47B 77/08; A47B 88/41; H05B 6/1209; A47B 88/437

(57) ABSTRACT

A cooker includes a top plate on which a heating object is to be placed, a heater configured to heat the heating object placed on the top plate, a housing provided below the top plate and accommodating the heater, a storage defined by a partition provided in the housing, a door configured to cover an opening provided at the housing and communicating with the storage, and an opening-and-closing mechanism configured to support the door and allow the door to be moved away from and toward the partition defining the storage. The opening-and-closing mechanism includes a first rail provided on the partition and extending in a depth direction of the storage, and a second rail connected to the door and allowed to be moved along the first rail.

### CROSS REFERENCE TO RELATED APPLICATION

This application is a U.S. national stage application of International Application No. PCT/JP2016/084030, filed on Nov. 17, 2016, which claims priority to Japanese Patent Application No. 2016-149832, filed on Jul. 29, 2016, the contents of which are incorporated herein by reference.

### TECHNICAL FIELD

The present invention relates to a cooker including a heater and a storage that are provided in a housing to be accommodated in an accommodating portion provided in a kitchen furniture item, and to a kitchen furniture item equipped with the cooker.

### BACKGROUND

There have been built-in-type cookers that are each installed by accommodating a housing of a cooker into a kitchen furniture item from a top opening provided at an upper surface of the kitchen furniture item, with a top board at the top of the housing of the cooker being exposed on the upper surface of the kitchen furniture item. As an example of such a cooker, there is a proposal of a cooker that includes a drawer-type storage provided in a housing of the cooker (see Patent Literature 1, for example).

### PATENT LITERATURE

Patent Literature 1: Japanese Unexamined Patent Application Publication No. 11-276354 (page 6)

In the cooker disclosed in Patent Literature 1, pieces of stuff such as cookware, tableware, and seasonings can be stored in the storage provided in the housing. However, Patent Literature 1 discloses no specific embodiments of a structure for drawing out the storage.

The housing of the cooker accommodates precision electronic components such as a control circuit that controls the heater. When the user opens or closes the door of the storage to bring out or put pieces of stuff from or into the cooker and thus vibration occurs, the vibration may be transmitted to the precision electronic components and cause malfunctions of the precision electronic components. In some cases, the housing of the cooker has a cooling-air passage for cooling the precision electronic components. In such a case, when the vibration caused by opening or closing of the door of the storage displaces any of the precision electronic components, heat conduction may be reduced because of, for example, poor contact between a heat-generating component and a storage, resulting in a failure in producing a desired cooling effect over the precision electronic components. As described above, the vibration occurring at opening or closing of the door of the heater may degrade the reliability of the cooker.

### SUMMARY

The present invention has been conceived in view of the above problems and provides a cooker in which degradation in reliability with vibration occurring at opening or closing of a door of a storage provided in a housing of the cooker can be reduced, and also provides a kitchen furniture item equipped with the cooker.

A cooker according to one embodiment of the present invention includes a top plate on which a heating object is to be placed, a heater configured to heat the heating object placed on the top plate, a housing provided below the top plate and accommodating the heater, a storage defined by a partition provided in the housing, a door configured to cover an opening provided at the housing and communicating with the storage, and an opening-and-closing mechanism configured to support the door and allow the door to be moved away from and toward the partition defining the storage. The opening-and-closing mechanism includes a first rail provided on the partition and extending in a depth direction of the storage, and a second rail connected to the door and allowed to be moved along the first rail.

A kitchen furniture item equipped with a cooker according to another embodiment of the present invention is a kitchen furniture item equipped with a cooker including a housing accommodating a heater and a top plate provided on the housing. The kitchen furniture item includes an accommodating portion in which the housing of the cooker is accommodated, a kitchen storage defined separately from the accommodating portion, a first door configured to cover an opening provided at the kitchen furniture item and communicating with the kitchen storage, and a first opening-and-closing mechanism configured to support the first door and allow the first door to be moved away from and toward a partition defining the kitchen storage. The cooker includes a storage defined by a partition provided in the housing, a second door configured to cover an opening provided at the housing and communicating with the storage, and a second opening-and-closing mechanism configured to support the second door and allow the second door to be moved away from and toward the partition defining the storage. The second opening-and-closing mechanism includes a first rail provided on the partition defining the storage and extending in a depth direction of the storage, and a second rail connected to the door and allowed to be moved along the first rail. A magnitude of a force required for the first opening-and-closing mechanism to allow the first door that is closed to be moved in an opening direction and a magnitude of a force required for the second opening-and-closing mechanism to allow the second door that is closed to be moved in an opening direction are equal, and a magnitude of a force required for the first opening-and-closing mechanism to allow the first door that is open to be moved in a closing direction and a magnitude of a force required for the second opening-and-closing mechanism to allow the second door that is open to be moved in a closing direction are equal.

According to an embodiment of the present invention, degradation in reliability with vibration occurring at opening or closing of the door of the storage provided in the housing of the cooker can be reduced.

### BRIEF DESCRIPTION OF DRAWINGS

FIG. 1 is a perspective view of a kitchen furniture item equipped with a cooker according to Embodiment 1.

FIG. 2 is a perspective view of a cooker according to Embodiment 1.

FIG. 3 is an exploded perspective view of the cooker according to Embodiment 1.

FIG. 4 is a lateral sectional view of the cooker according to Embodiment 1, taken across a storage.

FIG. 5 is an enlarged view of relevant part of the cooker according to Embodiment 1, illustrating an opening-and-closing mechanism.

FIG. 6 is a diagram illustrating the opening-and-closing mechanism of the cooker according to Embodiment 1.

FIG. 7 is an exploded perspective view of a cooker according to Embodiment 2.

FIG. 8 is an exploded perspective view of a storage door and components connected to the storage door according to Embodiment 2.

FIG. 9 is a diagram illustrating an opening-and-closing mechanism of the cooker according to Embodiment 2.

### DETAILED DESCRIPTION

Embodiments of the cooker and the kitchen furniture item equipped with a cooker according to the present invention will be described below with reference to the drawings. The present invention is not limited to the following embodiments illustrated in the drawings. In the following description, terms (such as “top”, “bottom”, “right”, “left”, “front”, and “rear”) representing directions and used appropriately for easy understanding are only explanatory, and the present invention is not limited to the directions represented by the terms. In the drawings, the same reference signs denote the same or similar elements, and the reference signs are common throughout this specification. The relative sizes, the shapes, and other details of the elements illustrated in the drawings may be different from the actual ones.

### Embodiment 1

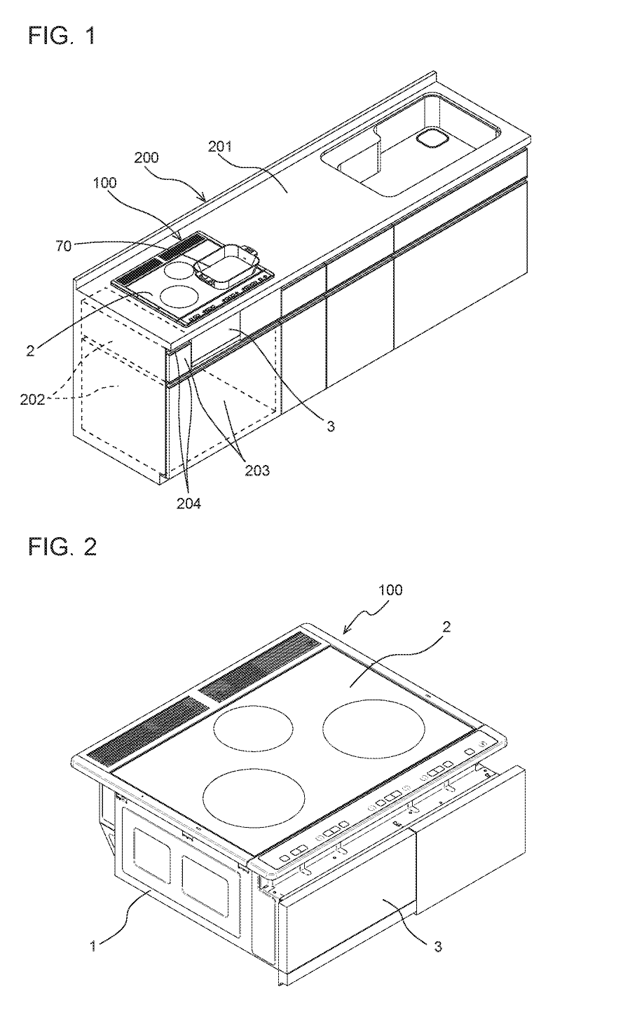

FIG. 1 is a perspective view of a kitchen furniture item equipped with a cooker according to Embodiment 1. As illustrated in FIG. 1, a kitchen furniture item 200 includes a cooker 100 built in the kitchen furniture item 200. The kitchen furniture item 200 has an accommodating portion (not illustrated), inside the kitchen furniture item 200, in which a housing 1 (see FIG. 2) of the cooker 100 is accommodated. The kitchen furniture item 200 has, at the top of the kitchen furniture item 200, a flat top board 201 used as a worktable. In a state where the cooker 100 is accommodated in the kitchen furniture item 200, a top plate 2 of the cooker 100 is exposed on the top board 201. The top plate 2 is provided with one or a plurality of cooking zones. For the convenience of description, FIG. 1 also illustrates a cooking pan 70 to be heated on the top plate 2.

The kitchen furniture item 200 has kitchen storages 202, inside the kitchen furniture item 200, in which pieces of stuff such as cookware and seasonings are to be stored. The kitchen furniture item 200 has, on the front face of the kitchen furniture item 200, kitchen-storage doors 203 that are each a first door that opens and closes an opening provided at the front face of a corresponding one of the kitchen storages 202. The kitchen-storage doors 203 each have a handhold 204 used as a grip for opening and closing a corresponding one of the kitchen-storage doors 203. When the user pulls one of the handholds 204, a corresponding one of the kitchen-storage doors 203 that is provided with that handhold 204 opens. The kitchen-storage doors 203 may be each allowed to be slid in the depth direction or may be each allowed to be opened and closed about a hinge provided on a lateral portion, the lower portion, or the upper portion of the kitchen-storage doors 203. In this specification, the “front face” of the cooker 100 or the “front face” of the kitchen furniture item 200 refers to a face of the cooker 100 or the kitchen furniture item 200 that faces the user.

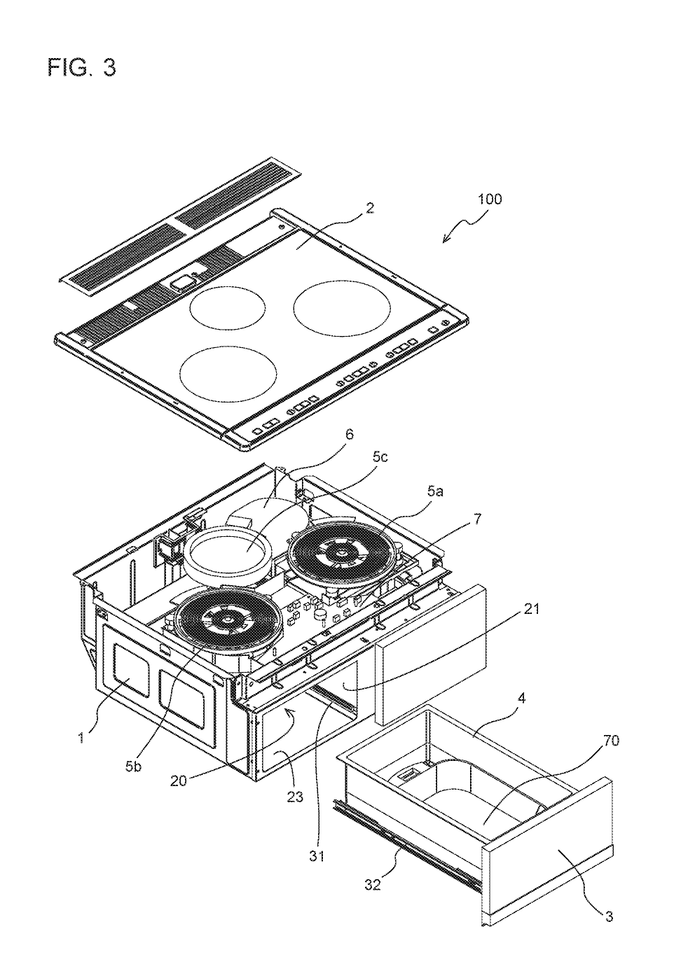

The cooker 100 has, on the front face of the cooker 100, a storage door 3 that is a second door that opens and closes an opening provided at the front face of a storage 20 (see FIG. 3) provided in the cooker 100. The storage door 3 is exposed on the front face of the kitchen furniture item 200.

FIG. 2 is a perspective view of the cooker according to Embodiment 1. The cooker 100 includes the housing 1 made of metal and in which components are accommodated. The housing 1 is provided, at the top of the housing 1, with the top plate 2 on which a cooking pan that is a heating object is to be placed. The top plate 2 is made of a nonmetallic material such as heat-resisting glass and ceramic. In Embodiment 1, the top plate 2 is enclosed by a metal frame. The top plate 2 has, on the front or back surface of the top plate 2, indications that are marks representing positions at any of which the heating object is to be placed.

FIG. 3 is an exploded perspective view of the cooker according to Embodiment 1. The housing 1 of the cooker 100 has a substantially box-like shape with the top face of the housing 1 open. The housing 1 of the cooker 100 accommodates two heating coils 5a and 5b and a radiant heater 5c that are heaters any of which heats the heating object to be placed on the top plate 2. The number and arrangement of the heating coils 5a and 5b and the radiant heater 5c illustrated in the drawing are only exemplary, and the present invention is not limited to the specific configuration and arrangement of the heaters.

The housing 1 accommodates a circuit board 7 on which an inverter that supplies a high-frequency current to the heating coils 5a and 5b, a drive circuit that drives the radiant heater 5c, and a control circuit are mounted. The control circuit of the cooker 100 controls the heaters in accordance with inputs made by the user, thereby heating the heating object placed on the top plate 2. The cooker 100 may have a cooking menu for controlling the heating operation in accordance with predetermined control sequences.

An air-sending device 6 is provided in the housing 1 and behind the heating coil 5a. The air-sending device 6 feeds cooling air into the housing 1 and thus cools heat-generating components mounted on the circuit board 7, the heating coil 5a, and the heating coil 5b.

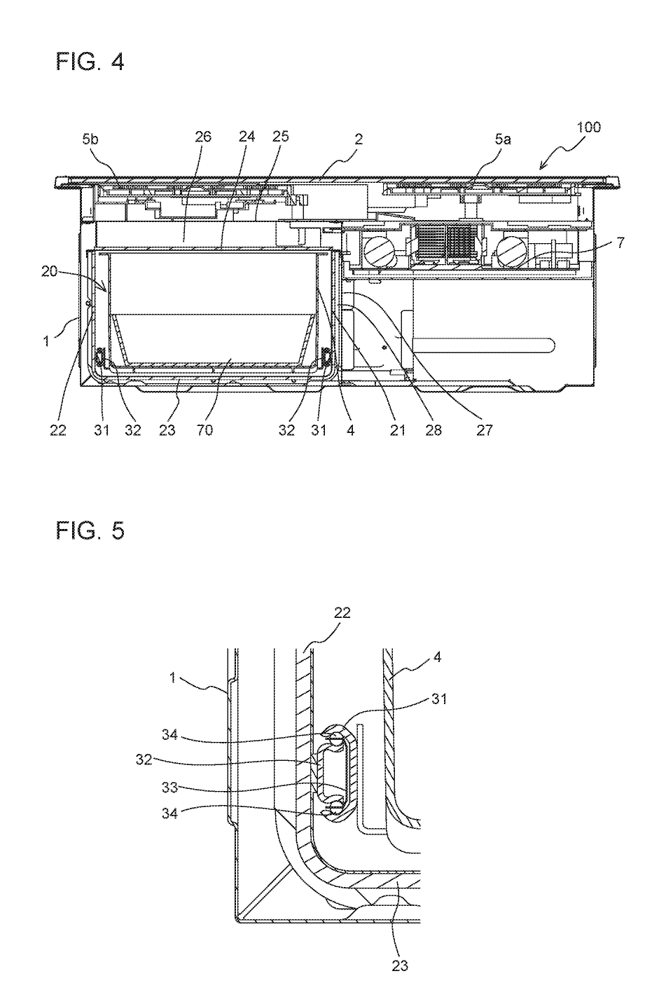

The housing 1 has the storage 20 defined in a substantially cuboid shape. Of a partition that defines the storage 20, the wall on the right is denoted as right wall 21, the wall on the left is denoted as left wall 22 (see FIG. 4), the wall forming the bottom is denoted as bottom board 23, and the wall forming the ceiling is denoted as upper board 24 (see FIG. 4). The storage 20 has an open part at the front face of the storage 20. Pieces of stuff are freely put into and brought out of the storage 20 through the open part. In Embodiment 1, the storage door 3 that covers the open part provided at the front face of the storage 20 is integrated with a box-shaped storage case 4 whose top face is open. With opening and closing of the storage door 3, the storage case 4 is pulled outward and pushed inward of the storage 20.

As an opening-and-closing mechanism that supports the storage door 3 in such a manner that the storage door 3 is allowed to be moved away from and toward the partition that defines the storage 20, Embodiment 1 employs a pair of right and left first rails 31 each provided on a corresponding one of the right wall 21 and the left wall 22 (see FIG. 4), and a pair of right and left second rails 32 connected to the storage door 3. In Embodiment 1, the second rail 32 is attached to a lower portion of each of the right and left faces of the storage case 4. The second rail 32 is in engagement with each of the first rails 31 in such a manner that the second rail 32 is allowed to be slid. With opening and closing of the storage door 3, the second rails 32 move in the depth direction while being guided by the first rails 31.

Hereinafter, the direction in which the kitchen-storage door 203 and the storage door 3 each move to be closed is referred to as “closing direction,” and the direction in which the kitchen-storage door 203 and the storage door 3 each move to be opened is referred to as “opening direction.”

The first rails 31 and the second rails 32 are provided with a locking mechanism that prevents the first rails 31 and the second rails 32 that are in engagement with each other from being disengaged from each other with the normal operation of opening or closing the storage door 3. When the user performs an unlocking operation, the first rails 31 and the second rails 32 can be separated from each other. As the second rails 32 are configured to separate from the first rails 31, the storage door 3 and the storage case 4 are allowed to be separated from the storage 20. For example, not only the cooking pan 70 to be used in the heating with the cooker 100 but also seasonings and other pieces of stuff are likely to be stored in the storage case 4. For this reason, the storage case 4 is required to be clean. Meanwhile, areas around the cooker 100 tend to become dirty with some food stuff, oil soot, steam, and other similar matter scattered during cooking. When the storage case 4 is configured to be detached from the storage 20 as in Embodiment 1, the user can easily clean the storage case 4. When the cooker 100 has the cooking menu mentioned above, the capacity of the storage case 4 may be determined in such a manner that a cooking pan to be used for the cooking menu can be stored in the storage case 4. When the storage case 4 is designed to store such a dedicated cooking pan, the ease of work in cooking can be increased. Furthermore, spaces around the kitchen furniture item 200 can be used efficiently.

FIG. 4 is a lateral sectional view of the cooker according to Embodiment 1, taken across the storage. A facing wall 25 is provided outside (upper part in FIG. 4) the upper board 24, which is part of the partition that defines the storage 20. A gap 26 is defined between the upper board 24 and the facing wall 25. The upper board 24 and the facing wall 25 are arranged in such a manner that the flat surfaces of the upper board 24 and the facing wall 25 face each other. The facing wall 25 and the gap 26 are present between the heating coil 5b and the upper board 24 of the storage 20. Another facing wall 27 is provided outside (right part in FIG. 4) the right wall 21, which is another part of the partition that defines the storage 20. A gap 28 is defined between the right wall 21 and the facing wall 27. The right wall 21 and the facing wall 27 are arranged in such a manner that the flat surfaces of the right wall 21 and the facing wall 27 face each other.

The gap 26 and the gap 28 may be each an air layer. Alternatively, a heat-insulating material may be provided in each of the gap 26 and the gap 28, or both an air layer and a heat-insulating material may be provided in each of the gap 26 and the gap 28. The heat-insulating material may be, for example, a synthetic resin material, a rubber-based or urethane-based closed-cell foam material, glass fibers, ceramic fibers, and any of other similar materials.

While Embodiment 1 is described focusing on the gap 26 and the gap 28 each provided outside a corresponding one of the upper board 24 and the right wall 21 of the partition that defines the storage 20, such a gap may be provided outside any of other parts of the partition.

FIG. 5 is an enlarged view of relevant part of the cooker according to Embodiment 1, illustrating the opening-and-closing mechanism. FIG. 5 illustrates a section in the vicinity of the first rail 31 and the second rail 32 that are provided to the left of the storage 20. The opening-and-closing mechanism according to Embodiment 1 includes, in addition to the first rails 31 and the second rails 32, carriage portions 33 each provided to a corresponding pair of the first rails 31 and the second rails 32, and a set of bearing balls 34 each held on a corresponding one of the upper surface and the lower surface of a corresponding one of the carriage portions 33. The first rails 31 each have a substantially C sectional shape. The second rails 32 also each have a substantially C sectional shape. The second rails 32 are each positioned inside a corresponding one of the first rails 31 in such a manner that a C-shaped concavity of the second rail 32 faces a C-shaped concavity of the first rail 31. The carriage portions 33, which also each have a substantially C sectional shape, are each accommodated in the C-shaped concavity of a corresponding one of the first rails 31. The bearing balls 34 are held by the carriage portions 33 in such a manner that the bearing balls 34 are allowed to rotate. The bearing balls 34 are positioned between upper portions of a corresponding pair of the first rails 31 and the second rails 32 and between lower portions of a corresponding pair of the first rails 31 and the second rails 32. When the second rails 32 are moved, the bearing balls 34 rotate. Hence, the second rails 32 can be moved with a smaller force of operation.

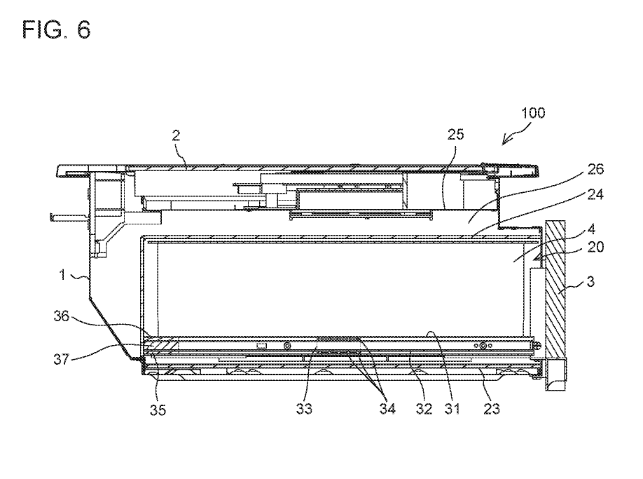

FIG. 6 is a diagram illustrating the opening-and-closing mechanism of the cooker according to Embodiment 1. FIG. 6 illustrates a section of the cooker 100 extending along a direction from the front to the back of the cooker 100 and along the first rail 31 and the second rail 32 provided to the left of the storage 20. The carriage portion 33 is provided with the plurality of bearing balls 34 aligned in the longitudinal direction of the first rail 31 and the second rail 32.

In Embodiment 1, a damping mechanism 35, an urging mechanism 36, and a push-open mechanism 37 are provided as part of the opening-and-closing mechanism. The damping mechanism 35 damps the traveling speed of the storage door 3 during a closing motion. Specifically, the damping mechanism 35 has a configuration that damps the traveling speed at which the second rails 32 move in the direction in which the storage door 3 is closed. More preferably, the damping mechanism 35 damps the traveling speed of the storage door 3 in such a manner that the traveling speed is reduced as the storage door 3 moves closer to a position for a closed state where the storage door 3 is completely closed. The damping mechanism 35 may be an oil damper, an air damper, or any other similar device. With the damping mechanism 35, the impact applied to the front face of the housing 1 from the storage door 3 at the closing of the storage door 3 can be reduced. Consequently, the deterioration and damage of the pieces of stuff in the storage 20 that may be caused by the impact can be reduced. Furthermore, in the configuration in which the storage case 4 is integrally attached to the storage door 3 as in Embodiment 1, when the traveling speed of the storage door 3 during the closing motion is too high, the pieces of stuff in the storage case 4 may fall over or collide with one another at the closing of the storage door 3 because of inertia. However, with the damping mechanism 35, such damage to the pieces of stuff in the storage case 4 that may occur when the pieces of stuff in the storage case 4 fall over or collide with one another can be reduced.

The urging mechanism 36 urges the storage door 3 in the closing direction. Specifically, the urging mechanism 36 generates a force that pulls the second rails 32 in the direction in which the storage door 3 is closed. The urging mechanism 36 may have, for example, a structure that utilizes the effect of magnets that attract each other, or a structure that utilizes the effect of gravity that pulls things down. As another exemplary structure, the urging mechanism 36 may include a coil spring or any of other similar springs that accumulates the force generated when the storage door 3 is pulled outward and is moved inward in the opening direction and utilizes the force as the force for pulling inward of the storage door 3. With the urging mechanism 36, the storage door 3 becomes less likely to stop during the closing motion. Hence, the probability that the storage door 3 is unintentionally left open can be reduced, and the ease of operation of the cooker 100 by the user can be increased.

The push-open mechanism 37 opens the storage door 3 when the storage door 3 that is closed is pushed in the depth direction of the storage 20. In this case, the state in which the storage door 3 is open refers to a state where the storage door 3 is away from the open part provided at the front face of the storage 20 and the open part is exposed. The push-open mechanism 37 may have a structure in which, for example, the push-open mechanism 37 locks and retains the positions of the storage door 3 and the second rails 32 when the storage door 3 is closed, whereas the push-open mechanism 37 unlocks the storage door 3 and the second rails 32 and allows the urging unit to push the second rails 32 and the storage door 3 forward when the storage door 3 is pushed in. With the push-open mechanism 37, the user can open the storage door 3 with an easy operation. When the push-open mechanism 37 is provided, the grip of the storage door 3 that is provided for opening and closing the storage door 3 may be omitted. In such a configuration, the manufacturing cost of the storage door 3 can be reduced, and the beauty in design of the storage door 3 can be increased.

The specific configurations of the damping mechanism 35, the urging mechanism 36, and the push-open mechanism 37 are not limited to those described in Embodiment 1, as long as the above functions are provided. The first rails 31, the second rails 32, the damping mechanism 35, the urging mechanism 36, and the push-open mechanism 37 that form the opening-and-closing mechanism can be each formed as a combination of general-purpose components. In such a case, the manufacturing cost of the cooker 100 can be reduced. Moreover, only any one or two of the damping mechanism 35, the urging mechanism 36, and the push-open mechanism 37 may be employed.

As described above, the cooker 100 according to Embodiment 1 includes the storage 20 defined by a partition provided in the housing 1. Furthermore, as the opening-and-closing mechanism that supports the storage door 3 covering the opening communicating with the storage 20 and allows the storage door 3 to be moved away from and toward the partition defining the storage 20, the cooker 100 includes the first rails 31 extending in the depth direction of the storage 20, and the second rails 32 connected to the storage door 3 and allowed to be moved along the first rails 31. Consequently, vibration of the partition defining the storage 20 that may occur with opening or closing motion of the storage door 3 can be reduced. The occurrence of malfunctions and displacement of the circuit board 7 and other components in the housing 1 that may be caused by the vibration transmitted from the storage 20 can be reduced, accordingly. Consequently, the degradation in the reliability of the cooker 100 can be reduced. Furthermore, the transmission of vibration to the pieces of stuff in the storage 20 can be reduced. Consequently, the deterioration and damage of the pieces of stuff due to the vibration can be reduced. When the opening-and-closing mechanism according to Embodiment 1 is not provided and the storage case 4 to which the storage door 3 is connected is directly in contact with and slides along any part of the partition defining the storage 20, changes in the dimensions of the partition defining the storage 20 that may occur with the heat generated in the housing 1 may make it difficult for the storage case 4 and the storage door 3 to move smoothly. In a state where the temperature in the housing 1 is high and particularly during heating, pulling and pushing of the storage case 4 may be hindered. However, with the opening-and-closing mechanism including the first rails 31 and the second rails 32 as in Embodiment 1, even when the dimensions of the partition defining the storage 20 change, the slidability of the first rails 31 and the second rails 32 can be maintained. Consequently, even during heating, the storage case 4 and the storage door 3 can be pulled outward and pushed inward smoothly.

Embodiment 1 employs the facing walls 25 and 27 provided outside the right wall 21 partly defining the storage 20, with the gap 28 defined between the facing walls 25 and 27 and the right wall 21. Thus, at least part of the storage 20 has a double-wall structure. Consequently, even when any vibration with opening or closing motion of the storage door 3 occurs in the right wall 21 to which the opening-and-closing mechanism is attached, the vibration is absorbed by the gaps 26 and 28 and is less likely to be transmitted to the heating coils 5a and 5b, the circuit board 7, and other components provided outside the facing walls 25 and 27. The occurrence of malfunctions and displacement of the circuit board 7 and other components in the housing 1 that may be caused by the vibration transmitted from the storage 20 can be further reduced, accordingly. Consequently, the degradation in the reliability of the cooker 100 can be further reduced.

### Embodiment 2

Embodiment 2 differs from Embodiment 1 in the specific configuration of the opening-and-closing mechanism provided for the storage door 3. Embodiment 2 will be described below, focusing on the difference from Embodiment 1.

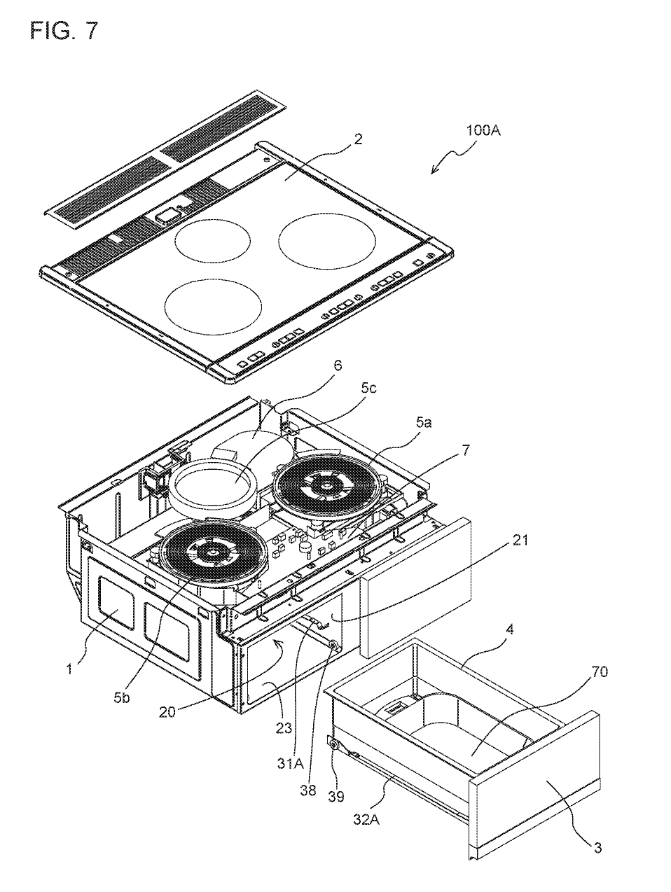

FIG. 7 is an exploded perspective view of a cooker according to Embodiment 2. As an opening-and-closing mechanism for the storage door 3, a cooker 100A according to Embodiment 2 includes first rails 31A, second rails 32A, first rollers 38, and second rollers 39. One of the first rails 31A is provided to the inner surface of the right wall 21 partly defining the storage 20 and extends in the depth direction of the storage 20. One of the first rollers 38 is supported on the right wall 21 in such a manner that the one of first rollers 38 is allowed to rotate in the opening-and-closing direction of the storage door 3, that is, in the depth direction of the storage 20. Although not illustrated in FIG. 7, the other first rail 31A and the other first roller 38 that are the same as those provided on the right wall 21 are provided to the inner surface of the left wall 22 (see FIG. 4) of the storage 20.

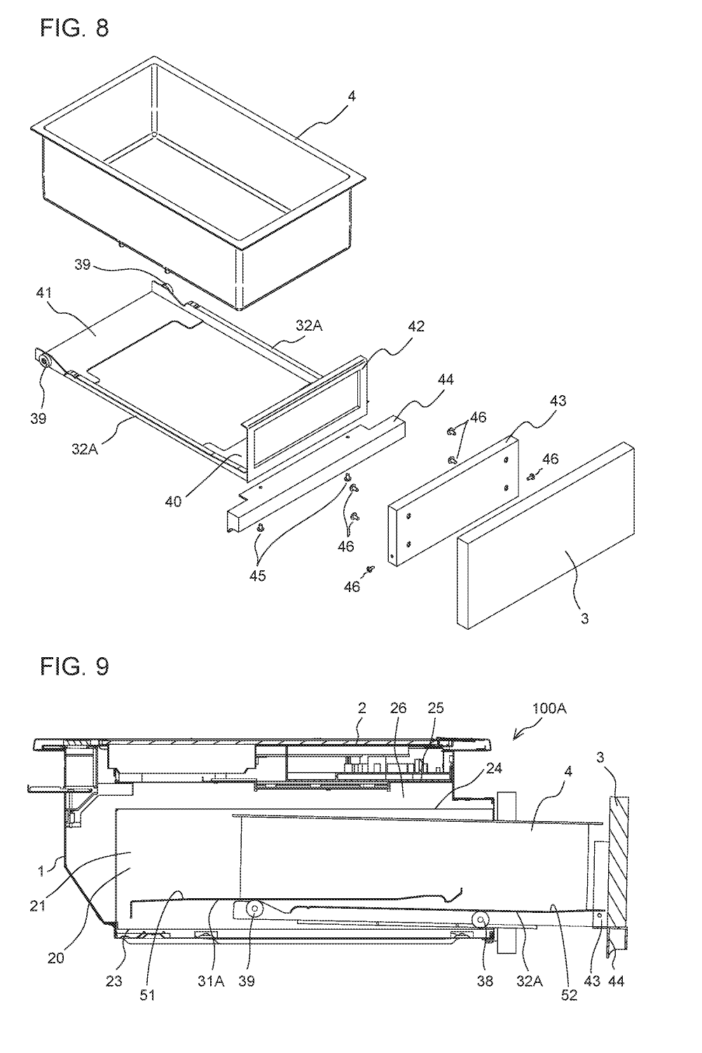

FIG. 8 is an exploded perspective view of the storage door and components connected to the storage door according to Embodiment 2. The pair of right and left second rails 32A are connected to each other with a first connecting portion 40 at the front ends of the second rails 32A and with a second connecting portion 41 at the rear ends of the second rails 32A. The first connecting portion 40 and the second connecting portion 41 are each a substantially flat plate-like part. The storage case 4 is placed on the flat surfaces of the first connecting portion 40 and the second connecting portion 41 in such a manner that the storage case 4 is allowed to be removed. The second rails 32A are provided, at the front ends of the second rails 32A, with a front board 42 having a flat surface extending in the vertical direction. The front board 42 also has a function of connecting the pair of right and left second rails 32A.

To the front portion of the front board 42, a substantially flat plate-like intermediate part 43 is attached. The storage door 3 is attached to the front portion of the intermediate part 43 with screws 46 in such a manner that the storage door 3 is allowed to be detached. The storage door 3 according to Embodiment 2 is connected to the second rails 32A with the intermediate part 43 and the front board 42 interposed between the storage door 3 and the second rails 32A. A handhold 44 serving as a grip for opening and closing the storage door 3 is attached to the lower portion of the front board 42 with screws 45 in such a manner that the handhold 44 is allowed to be detached.

In a state where the parts illustrated in FIG. 8 have been assembled altogether, the first connecting portion 40 and the second connecting portion 41 connected to the pair of right and left second rails 32A support the storage case 4 from below, and the second rails 32A and the storage case 4 move together when the storage door 3 is opened or closed. The storage case 4 is allowed to be removed from the second rails 32, the first connecting portion 40, and the second connecting portion 41 and is therefore solely washable with water. Thus, the ease of cleaning and the cleanliness of the storage case 4 can be increased.

The second roller 39 is provided at the tip of each of the second rails 32A, that is, at a position farther from the storage door 3 than is each of the second rails 32A. In Embodiment 2, the second rollers 39 are supported on thin plate-like portions extending continuously from the tips of the second rails 32A in such a manner that the second rollers 39 are allowed to rotate. The second rollers 39 rotate in the opening-and-closing direction of the storage door 3, that is, in the longitudinal direction of the second rails 32A.

FIG. 9 is a diagram illustrating the opening-and-closing mechanism of the cooker according to Embodiment 2. FIG. 9 is a sectional view of the cooker 100A extending along a direction from the front to the back of the cooker 100A and along the first rail 31A and the second rail 32A provided to the right of the storage 20 and illustrates a state where the storage door 3 is open. In the opening-and-closing mechanism according to Embodiment 2, the second roller 39 is positioned below each of the first rails 31A. When the storage door 3 is opened or closed, the second rollers 39 that are each in contact with the lower surface of a corresponding one of the first rails 31A move while rotating. The second rail 32A is positioned on the upper surface of a corresponding one of the first rollers 38. When the storage door 3 is opened or closed, the second rails 32A move on the first rollers 38, and the first rollers 38 thus rotate. With this configuration, with the aid of the second roller 39 that moves along the first rail 31A provided on the right wall 21, the second rail 32A also moves along the first rail 31A.

As illustrated in FIG. 9, the first rails 31A each have a linear shape extending substantially in the depth direction of the storage 20 as a whole, but a portion of each of the first rails 31A that is closer to the rear end than are each of first bent points 51 that are each on the rear part of a corresponding one of the first rails 31A is inclined downward. The second rails 32A also each have a linear shape extending substantially in the depth direction of the storage 20 as a whole, but a portion of each of the second rails 32A that is closer to the front end than are each of second bent points 52 that are each on the front part of a corresponding one of the second rails 32A is inclined upward. The rear end portion of each of the first rails 31A inclines downward, whereas the front end portion of each of the second rails 32A inclines upward. Consequently, when the storage door 3 is closed, the storage door 3 under the gravity is urged in the direction in which the storage door 3 is closed. That is, in Embodiment 2, the structure of the first rails 31A that each bend downward from a corresponding one of the first bent points 51 and the structure of the second rails 32A that each bend upward from a corresponding one of the second bent points 52 in combination serve as an urging mechanism that urges the storage door 3 in the closing direction. With such an urging mechanism, the storage door 3 becomes less likely to stop during the closing motion. Hence, the probability that the storage door 3 is unintentionally left open can be reduced, and the ease of operation of the cooker 100A by the user can be increased. The urging mechanism may have another configuration instead of the specific configuration illustrated in FIG. 9, as long as the above function is provided.

The opening-and-closing mechanism for the storage door 3 according to Embodiment 2 may include a damping mechanism and a push-open mechanism that have the same functions as those described in Embodiment 1.

As described above, the cooker 100A according to Embodiment 2 includes the storage 20 defined by the partition provided in the housing 1. Furthermore, as the opening-and-closing mechanism that supports the storage door 3 covering the opening communicating with the storage 20 and allows the storage door 3 to be moved away from and toward the partition defining the storage 20, the cooker 100A includes the first rails 31A extending in the depth direction of the storage 20, and the second rails 32A connected to the storage door 3 and allowed to be moved along the first rails 31A. Consequently, vibration of the partition defining the storage 20 that may occur with opening or closing motion of the storage door 3 can be reduced. The occurrence of malfunctions and displacement of the circuit board 7 and other components in the housing 1 that may be caused by the vibration transmitted from the storage 20 can be reduced, accordingly. Consequently, the degradation in the reliability of the cooker 100A can be reduced. Furthermore, the transmission of vibration to the pieces of stuff in the storage 20 can be reduced. Consequently, the deterioration and damage of the pieces of stuff due to the vibration can be reduced.

### Embodiment 3

In Embodiment 3, an opening-and-closing mechanism provided for the kitchen-storage door 203 of the kitchen furniture item 200 will be described, appropriately referring to the cooker 100 described in Embodiment 1 or the cooker 100A described in Embodiment 2.

The opening-and-closing mechanism that supports the kitchen-storage door 203 in such a manner that the kitchen-storage door 203 is allowed to be moved away from and toward the kitchen storage 202 may be an opening-and-closing mechanism having the same basic configuration as that of the opening-and-closing mechanism for the storage door 3 of the cooker 100 described in Embodiment 1, or an opening-and-closing mechanism having the same basic configuration as that of the opening-and-closing mechanism for the storage door 3 of the cooker 100A described in Embodiment 2. Furthermore, the opening-and-closing mechanisms provided for the kitchen-storage door 203 and for the storage door 3 are configured in such a manner that the magnitude of a force required for the storage door 3 that is closed and stationary to move in the opening direction and the magnitude of a force required for the kitchen-storage door 203 that is closed and stationary to move in the opening direction are the same and the magnitude of a force required for the storage door 3 that is open and stationary to move in the closing direction and the magnitude of a force required for the kitchen-storage door 203 that is open and stationary to move in the closing direction are the same. Thus, a uniform feeling of operation is provided to the storage door 3 of the cooker 100 and the kitchen-storage door 203, and the user can comfortably open and close the doors without feeling uncomfortable. Herein, the expression that the magnitude of the force is “the storage door 3 and the kitchen-storage door 203 are the same” does not necessarily refer to exactly the same state, and a certain difference that does not give any uncomfortable feeling of operation to the user is allowed. This explanation also applies to the following description. More preferably, the opening-and-closing mechanism for the storage door 3 and the opening-and-closing mechanism for the kitchen-storage door 203 are made of the same components. Thus, the uniformity of operation can be increased, and the increase in the manufacturing cost of the kitchen furniture item 200 equipped with the cooker can be reduced.

The opening-and-closing mechanism for the kitchen-storage door 203 may include a damping mechanism that damps the traveling speed of the kitchen-storage door 203 during the closing motion. In such a case, it is preferable that the damping mechanism 35 provided for the storage door 3 of the storage 20 and the damping mechanism provided for the kitchen-storage door 203 be configured in such a manner that the traveling speed after damping is the same between the two. Thus, a uniform feeling of operation is provided to the storage door 3 of the storage 20 and the kitchen-storage door 203, and the user can comfortably open and close the doors without feeling uncomfortable. More preferably, the damping mechanism for the storage door 3 and the damping mechanism for the kitchen-storage door 203 are made of the same components. Thus, the uniformity of operation can be increased, and the increase in the manufacturing cost of the kitchen furniture item 200 equipped with the cooker can be reduced.

The opening-and-closing mechanism for the kitchen-storage door 203 may include an urging mechanism that urges the kitchen-storage door 203 in the closing direction. In such a case, the urging mechanism provided for the storage door 3 of the storage 20 and the urging mechanism provided for the kitchen-storage door 203 are configured in such a manner that the urging start position and the urging force are the same between the two. Thus, a uniform feeling of operation is provided to the storage door 3 of the storage 20 and the kitchen-storage door 203, and the user can comfortably open and close the doors without feeling uncomfortable. More preferably, the urging mechanism for the storage door 3 and the urging mechanism for the kitchen-storage door 203 are made of the same components. Thus, the uniformity of operation can be increased, and the increase in the manufacturing cost of the kitchen furniture item 200 equipped with the cooker can be reduced.

The opening-and-closing mechanism for the kitchen-storage door 203 may include a push-open mechanism that opens the kitchen-storage door 203 when the kitchen-storage door 203 that is closed is pushed in the depth direction of the kitchen storage 202. In such a case, the push-open mechanism provided for the storage door 3 of the storage 20 and the push-open mechanism provided for the kitchen-storage door 203 are configured in such a manner that the pushing load and the length of pushing are the same between the two. Thus, a uniform feeling of operation is provided to the storage door 3 of the storage 20 and the kitchen-storage door 203, and the user can comfortably open and close the doors without feeling uncomfortable. More preferably, the push-open mechanism for the storage door 3 and the push-open mechanism for the kitchen-storage door 203 are made of the same components. Thus, the uniformity of operation can be increased, and the increase in the manufacturing cost of the kitchen furniture item 200 equipped with the cooker can be reduced.

In Embodiment 3, the opening-and-closing mechanism for the kitchen-storage door 203 corresponds to the first opening-and-closing mechanism according to the present invention, and the opening-and-closing mechanism for the storage door 3 corresponds to the second opening-and-closing mechanism according to the present invention. Furthermore, the damping mechanism, the urging mechanism, and the push-open mechanism for the kitchen-storage door 203 correspond to the first damping mechanism, the first urging mechanism, and the first push-open mechanism, respectively, according to the present invention. Furthermore, the damping mechanism, the urging mechanism, and the push-open mechanism for the storage door 3 correspond to the second damping mechanism, the second urging mechanism, and the second push-open mechanism, respectively, according to the present invention.

1. A cooker, comprising:
a top plate on which a heating object is to be placed;
a heater configured to heat the heating object placed on the top plate;
a housing provided below the top plate and accommodating the heater;
a storage defined by a partition provided in the housing, the storage being for storing a piece of stuff;
a door configured to cover an opening provided at the housing and communicating with the storage; and
an opening-and-closing mechanism configured to support the door and allow the door to be moved away from and toward the partition defining the storage,
the opening-and-closing mechanism including
a first rail provided on the partition and extending in a depth direction of the storage, and
a second rail connected to the door and allowed to be moved along the first rail.

2. The cooker of claim 1, wherein the second rail is in engagement with the first rail in such a manner that the second rail is allowed to be slid.

3. The cooker of claim 1, wherein the opening-and-closing mechanism includes
a first roller supported on the partition in such a manner that the first roller is allowed to rotate in an opening-and-closing direction of the door, the first roller supporting the second rail from below, and
a second roller supported at a position farther from the door than is the second rail in such a manner that the second roller is allowed to rotate in the opening-and-closing direction of the door, the second roller supporting the first rail from below.

4. The cooker of claim 1, wherein the opening-and-closing mechanism includes a damping mechanism configured to damp a traveling speed of the door during a closing motion.

5. The cooker of claim 1, wherein the opening-and-closing mechanism includes an urging mechanism configured to urge the door in a closing direction.

6. The cooker of claim 1, wherein the opening-and-closing mechanism includes a push-open mechanism configured to open the door when the door that is closed is pushed in the depth direction of the storage.

7. The cooker of claim 1, further comprising a facing wall provided outside the partition defining the storage, the facing wall facing at least part of the partition with a gap defined between the facing wall and the partition.

8. The cooker of claim 1, further comprising a cooking pan to be heated by the heater, the cooking pan being stored in the storage.

9. A kitchen furniture item equipped with a cooker including a housing accommodating a heater and a top plate provided on the housing, the kitchen furniture item equipped with the cooker comprising:
an accommodating portion in which the housing of the cooker is accommodated;
a kitchen storage defined separately from the accommodating portion;
a first door configured to cover an opening provided at the kitchen furniture item equipped with the cooker and communicating with the kitchen storage; and
a first opening-and-closing mechanism configured to support the first door and allow the first door to be moved away from and toward a partition defining the kitchen storage,
the cooker including
a storage defined by a partition provided in the housing, the storage being for storing a piece of stuff,
a second door configured to cover an opening provided at the housing and communicating with the storage, and
a second opening-and-closing mechanism configured to support the second door and allow the second door to be moved away from and toward the partition defining the storage,
the second opening-and-closing mechanism including a first rail provided on the partition defining the storage and extending in a depth direction of the storage, and a second rail connected to the second door and allowed to be moved along the first rail,
a magnitude of a force required for the first opening-and-closing mechanism to allow the first door that is closed to be moved in an opening direction and a magnitude of a force required for the second opening-and-closing mechanism to allow the second door that is closed to be moved in an opening direction being equal,
a magnitude of a force required for the first opening-and-closing mechanism to allow the first door that is open to be moved in a closing direction and a magnitude of a force required for the second opening-and-closing mechanism to allow the second door that is open to be moved in a closing direction being equal.

10. The kitchen furniture item equipped with a cooker of claim 9, wherein the first opening-and-closing mechanism and the second opening-and-closing mechanism have a same configuration.

11. The kitchen furniture item equipped with a cooker of claim 9,
wherein the first opening-and-closing mechanism includes a first damping mechanism configured to damp a traveling speed of the first door during a closing motion,
wherein the second opening-and-closing mechanism includes a second damping mechanism configured to damp a traveling speed of the second door during a closing motion, and
wherein the traveling speed after damping by the first damping mechanism and the traveling speed after damping by the second damping mechanism are equal.

12. The kitchen furniture item equipped with a cooker of claim 9,
wherein the first opening-and-closing mechanism includes a first urging mechanism configured to urge the first door in the closing direction,
wherein the second opening-and-closing mechanism includes a second urging mechanism configured to urge the second door in the closing direction, and
wherein an urging start position and an urging force of the first urging mechanism and an urging start position and an urging force of the second urging mechanism are equal.

13. The kitchen furniture item equipped with a cooker of claim 9,
wherein the first opening-and-closing mechanism includes a first push-open mechanism configured to open the first door when the first door that is closed is pushed in a depth direction of the kitchen storage,
wherein the second opening-and-closing mechanism includes a second push-open mechanism configured to open the second door when the second door that is closed is pushed in the depth direction of the storage, and
wherein a pushing load and a length of pushing required for the first push-open mechanism to open the first door and a pushing load and a length of pushing required for the second push-open mechanism to open the second door are equal.

14. The kitchen furniture item equipped with a cooker of claim 13, wherein the first push-open mechanism and the second push-open mechanism have a same configuration.

15. The kitchen furniture item equipped with a cooker of claim 9, wherein the second opening-and-closing mechanism includes
a first roller supported on the partition defining the storage in such a manner that the first roller is allowed to rotate in an opening-and-closing direction of the second door, the first roller supporting the second rail from below, and
a second roller supported at a position farther from the second door than is the second rail in such a manner that the second roller is allowed to rotate in the opening-and-closing direction of the second door, the second roller supporting the first rail from below.

16. The kitchen furniture item equipped with a cooker of claim 9, further comprising a facing wall provided outside the partition defining the storage of the cooker, the facing wall facing at least part of the partition with a gap defined between the facing wall and the partition.
